(19) United States
(12) Patent Application Publication
(10) Pub. No.: US 2014/0216170 A1
(43) Pub. Date: Aug. 7, 2014

(54) Systems And Methods For Monitoring Cutting Forces In Peripheral End Milling

(71) Applicant: Georgia Tech Research Corporation, Atlanta, GA (US)

(72) Inventors: Lei Ma, Atlanta, GA (US); Shreyes Melkote, Roswell, GA (US); John Morehouse, Atlanta, GA (US)

(73) Assignee: Georgia Tech Research Corporation, Atlanta, GA (US)

(21) Appl. No.: 14/173,752

(22) Filed: Feb. 5, 2014

Related U.S. Application Data
(60) Provisional application No. 61/760,709, filed on Feb. 5, 2013.

(51) Int. Cl. B23Q 17/09; G01L 1/22

(52) U.S. Cl. CPC B23Q 17/0966; G01L 1/22
USPC 73/862.06; 73/862.68

(57) ABSTRACT

Systems and methods for monitoring cutting forces in a peripheral end milling process are disclosed. The systems and methods comprise a sensor module that integrates a thin-film Polyvinylidene Fluoride (PVDF) piezoelectric strain sensor and an in situ data logging platform for monitoring such cutting forces. The module, which may be mounted on the tool shank, measures the dynamic strain(s) produced in the tool and logs the data into an on-board card for later retrieval. The close proximity between the signal source and the PVDF sensor(s) minimizes the attenuation and distortion of the signal along the transmitting path and provides high-fidelity signals. Further, the module facilitates the employment of a first-principles model based on Euler-Bernoulli beam theory and the constitutive equations of the piezoelectric sensor material to relate the in situ-measured PVDF sensor signals to the feed and transverse forces acting on the tool.

### CROSS REFERENCE TO RELATED APPLICATION

This application claims benefit under 35 U.S.C. §119(e) of U.S. Provisional Patent Application No. 61/760,709, filed Feb. 5, 2013, and entitled “Thin-Film PVDF Sensor-Based Monitoring of Cutting Forces in Peripheral End Milling,” which is incorporated herein by reference as if set forth herein in its entirety.

### BACKGROUND

Machining process monitoring is a critical aspect of machining process automation and has long been pursued by researchers. Over twenty years ago, researches attempted to monitor the turning process with embedded thin film sensors. Different types of sensors such as piezoelectric ZnO films, acoustic emission sensors, resistance thermometers, thin film thermocouples, and thin film strain gauges have been used in various machining processes including milling, turning, grinding, lapping, and chemical mechanical polishing.

Recently, the application of wireless sensing in machining operations has attracted the interest of the research community. Specifically, it has been demonstrated that tool temperature and spindle vibration data can be acquired wirelessly by embedding low profile sensors and wireless transmitters into cutting tools and spindle housings. Also, attempts have been made to wirelessly detect the onset of chatter, predict chatter frequency, measure cutting torque, predict cutting forces, and monitor tool wear in the milling process using an instrumented end mill. In certain instances, such as monitoring tool wear, the mechanistic model suffers from the drawback that the model coefficients depend on the workpiece and cutting tool materials. Therefore, if either material is changed, the model requires recalibration. Others have recently demonstrated wireless cutting temperature data acquisition from a thermal sensor embedded under the rake face of a PCBN insert. Embedding a thermal sensor under the rake face of the PCBN insert, however, significantly increases the cost of tool production.

Thin film sensors have been proposed as a promising candidate as strain gauges for surface strain and temperature measurement. They can be either sputtered onto the specimen or simply attached to the specimen using adhesives. Although the first method provides a more secure bond, the latter approach is more economical and practical. But, for the sensor to be mounted on a specimen of irregular shape, the sensor must be sufficiently flexible. Thin film Polyvinylidene Fluoride (PVDF) piezoelectric sensors possess this characteristic. In addition, they are low cost and offer a wide bandwidth (with resonant frequency above 10 MHz), fast response, high dynamic range (up to 2% strain), high strain sensitivity (generally in the range of 10 mV/με, where με represents “micro strain”) and differential sensitivity along the geometric axes of the sensor. Examples of PVDF sensors in strain sensing can be found in the literature and are known to those of ordinary skill in the art.

Among the large number of machining process responses, the feed and transverse forces are of paramount practical significance since they can be used as a proxy for the detection of tool wear, tool breakage, material abnormalities, and chatter. The current state-of-the-art for accurate measurement of forces in milling consists of platform or rotating piezoelectric force dynamometers. These force-sensing systems suffer, however, from several limiting drawbacks including: (1) large size, fragility, and intrusiveness to the process, (2) lowering of dynamic stiffness of the cutting tool/workpiece/spindle/machine tool system, (3) limited bandwidth (typically in the range of 2-4 KHz), (4) high cost, and (5) dependence on workpiece size (for platform dynamometers). Several attempts have been made to measure the cutting forces with force/torque sensors integrated into the spindle housing. These methods usually require significant installation effort and the signal is usually corrupted by the spindle dynamics and inertial forces. Also, the sensitivity of such a measuring system is typically low because of the long transmitting path between the signal source (i.e., cutting zone) and the signal pick-up location(s). The novel method of correlating forces with the control signals of active electromagnetic spindle bearings is not applicable when other types of bearings are used. Other methods such as correlating the feed motor current with cutting forces, strain-gauge-based torque sensor, and platform dynamometers and indirect force measurement via the acceleration signal suffer from the drawback of low bandwidth. Although certain measurement systems are capable of measuring the cutting forces acting on individual cutting inserts, such systems generally have high cost and intrusiveness that inhibits their practical usefulness.

Therefore, there is a long-felt but unresolved need for a system or method for monitoring of the cutting forces in the peripheral end milling process that is low-cost and non-intrusive.

### SUMMARY

Some or all of the above needs may be addressed by certain implementations of the disclosed technology. According to an example embodiment, a method is provided. The method includes generating an electric charge at a strain gauge in response to cutting force information, amplifying the electric charge with a charge amplifier into one or more voltage signals, filtering the one or more voltage signals with a filter, acquiring one or more digital voltage samples with a processing medium from the one or more voltage signals at a predetermined sampling period, and storing the one or more digital voltage samples on a digital storage medium for additional processing.

According to another example embodiment, a system is provided. The system comprises a plurality of strain gauges mounted to a machine, wherein the plurality of strain gauges are configured to generate an electric charge in response to cutting force information; a processing unit in communication with the plurality of strain gauges comprising: a charge amplifier, wherein the charge amplifier is configured to amplify the electric charge into one or more voltage signals; a filter, wherein the filter is configured to filter the one or more voltage signals; a processing medium, wherein the processing medium is configured to acquire one or more digital voltage samples from the one or more voltage signals at a predetermined sampling period; a digital storage medium, wherein the digital storage medium is configured to store the one or more digital voltage samples for further processing.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a force measurement system setup for peripheral end milling, according to one embodiment.

FIG. 2 is an exemplary illustration of a signal flow of a force measurement system for peripheral end milling, according to one embodiment.

FIG. 3 is an exemplary schematic of PVDF sensor deployment for a force measurement system setup for a peripheral end milling process, according to one embodiment.

FIG. 4 illustrates an exemplary frequency response function of the force measurement system setup for peripheral end milling as shown in FIG. 1, according to one embodiment.

FIG. 5 is an exemplary schematic of a PVDF sensor element, according to one embodiment.

FIG. 6 illustrates an exemplary angular span of a PVDF sensor on a cutting tool shank, according to one embodiment.

FIG. 7 is an exemplary Bode plot of the transfer function of signal conditioning circuitry, according to one embodiment.

FIG. 8 illustrates the backward comparison between the reference signal and the in-situ-measured PVDF sensor signal from Cutting Test 1 as shown in Table 1.

FIG. 9 illustrates the backward comparison between the reference signal and the in-situ-measured PVDF sensor signal from Cutting Test 10 as shown in Table 1.

FIG. 10 illustrates the backward comparison between the reference signal and the in-situ-measured PVDF sensor signal from Cutting Test 15 as shown in Table 1.

FIG. 11 illustrates the backward comparison between the reference signal and the in-situ-measured PVDF sensor signal from Cutting Test 17 as shown in Table 1.

FIG. 12 is an exemplary illustration of a signal flow of showing discrete time compensation of attenuation and distortion introduced by signal conditioning circuitry.

FIG. 13 illustrates a forward comparison between forces calculated from a PVDF sensor signals and dynamometer measurements.

FIG. 14 illustrates a second forward comparison between forces calculated from a PVDF sensor signals and dynamometer measurements.

FIG. 15 illustrates two exemplary bending strain rosette configurations on a circular beam, according to one embodiment.

FIG. 16 illustrates an exemplary shear strain rosette configuration on a circular beam, according to one embodiment.

FIG. 17 illustrates an exemplary axial strain rosette configuration, according to one embodiment.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Where appropriate, units are provided in parenthesis following the definition. Additionally, whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. But, the capitalization or lack thereof within the remainder of this document is not intended to be necessarily limiting unless the context clearly indicates that such limitation is intended.

### Definitions/Glossary

Aᵢ=Area of the PVDF sensor electrodes whose surface normal is parallel to the corresponding component i of the electric displacement field vector (m²)
C_{F}=Capacitance of the capacitor in the charge amplifier feedback loop (Farad)
D_{O}=Shank diameter of the end mill (m)
D=Electric displacement field vector (C/m²)
E=Electric field vector (V/m)
Eᵢ=Young's modulus of the PVDF sensor along the i^{th} axis (N/m²)
Eₜ=Young's modulus of the end mill (N/m²)
Fₓ=Transverse force (N)
F_{y}=Feed force (N)
F_{z}=Axial force (N)
Fᵣ=Radial force (N)
Fₜ=Tangential cutting force (N)
G(s)=Continuous time transfer function matrix between cutting forces and strain at the location of the PVDF sensor
G_{AA}(s) =Continuous time transfer function matrix of the anti-aliasing filter
G_{AA}(z) =Discretized version of G_{AA}(s)
G_{C}(s) =Continuous time transfer function matrix of the charge amplifier circuitry
G_{C}(z)=Discretized version of G_{C}(s)
G_{COMP}(z)=Discrete transfer function of the FIR compensation filter
G_{PVDF}(s)=Transfer function matrix between the strain picked up by the PVDF sensor and the charges generated on the electrodes of the PVDF sensor
Hₓᵢ=The distance from the center of PVDF sensor i to the neutral axis with respect to bending moment created by Fₓ(m)
H_{yi}=The distance from the center of PVDF sensor i to the neutral axis with respect to bending moment created by F_{y}(m)
L=Distance from the idealized concentrated feed/transverse force to the center of the PVDF sensor (m)
Vᵢ=Voltage generated between the electrodes of PVDF sensor i (V)
α=Half of the angular span of the PVDF sensor when mounted on the cutting tool shank (radian)
d =Piezoelectric stress coefficient matrix (C/N)
e^{σ}=Dielectric permittivity matrix at a constant stress field (Farad/m)
s^{E}=Elastic compliance matrix at a constant electric field (m²/N)
t=Elapsed time since the start of tool rotation (s)
qᵢ=Electric charge generated at the electrodes of PVDF sensor i (C)
ε=Strain vector
ε_{iα}=Axial strain in end mill at the location of PVDF sensor i
εᵢ=Axial strain to the i^{th} axis of the PVDF sensor
εᵢₜ=Transverse strain in the end mill at the location of the PVDF sensor i
θ=Angular position of the PVDF sensor with respect to the machine-centered coordinate system (radian)
κ=Strain transfer coefficient of the adhesive
σ=Stress vector (N/m²)
vₜ=Poisson's ration of the end mill
φ₀=Initial angular position of tool with respect to the machine-centered coordinate system (radian)
ω₀=Angular velocity of the cutting tool (radian/s)
Subscript_{i,j,k,l,m}=coordinates

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for monitoring various end milling cutting forces (e.g., the feed and transverse forces) in a peripheral end milling process. In particular, aspects of the present disclosure relate to a sensor module that integrates a thin-film Polyvinylidene Fluoride (PVDF) piezoelectric strain sensor/gauge that receive information relating to various end milling cutting forces (i.e., cutting force information). Further, aspects of the present disclosure relate to a sensor module that further integrates an in situ data logging platform for monitoring of end milling cutting forces (e.g., feed and transverse forces). Though the data logging platform described is in situ, it is contemplated that wireless functionality can be integrated into the disclosed hardware. The disclosed systems and methods take advantage of low-cost PVDF sensors, which offer a unique combination of high flexibility, wide bandwidth, fast response, high dynamic range, high strain sensitivity, and differential sensitivity along the various geometric axes.

The disclosed systems and methods further comprise various physics-based models that relate PVDF sensor signals to various end milling cutting forces. For example, in one embodiment, PVDF sensors receive information relating to various end milling cutting forces (i.e., cutting force information). Signal conditioning and data logging electronics may utilize the various physics-based models included in the disclosed systems and methods to process the received cutting force information and generate various cutting force data that can be used to relate the cutting force information to the actual end milling cutting forces (e.g., cutting forces acting on the end mill flute region). In various embodiments, this cutting force data can be used for detecting chatter, monitoring tool wear, detecting tool breakage, etc. For example, in one embodiment, a suitable processing algorithm based on the received cutting force information and generated cutting force data can be devised to detect machining vibrations (i.e., chatter). Similarly, various algorithms can be developed to detect tool wear or tool breakage based on the. Additionally, various other algorithms based on received cutting force information and cutting force data generated by the presently-disclosed systems and methods can be generated, as will be understood by those of ordinary skill in the art.

The high-fidelity PVDF signals acquired using the custom data logging unit of the presently-disclosed systems and methods have been demonstrated to compare well with force signals measured from a piezoelectric platform dynamometer. In certain embodiments, it is necessary to calibrate the disclosed measurement system. For example, when exact values material constants of the cutting tool and PVDF sensor are not available, the employment of a model-based approach enables the calibrated measurement system to function independently of the workpiece material. In one embodiment, the PVDF sensor is calibrated against a dynamometer force signal, and where the PVDF signal represents a distorted version of the cutting force signal, a least squares finite impulse response filter can be introduced in the discrete time domain to recover the original form of the cutting force signals.

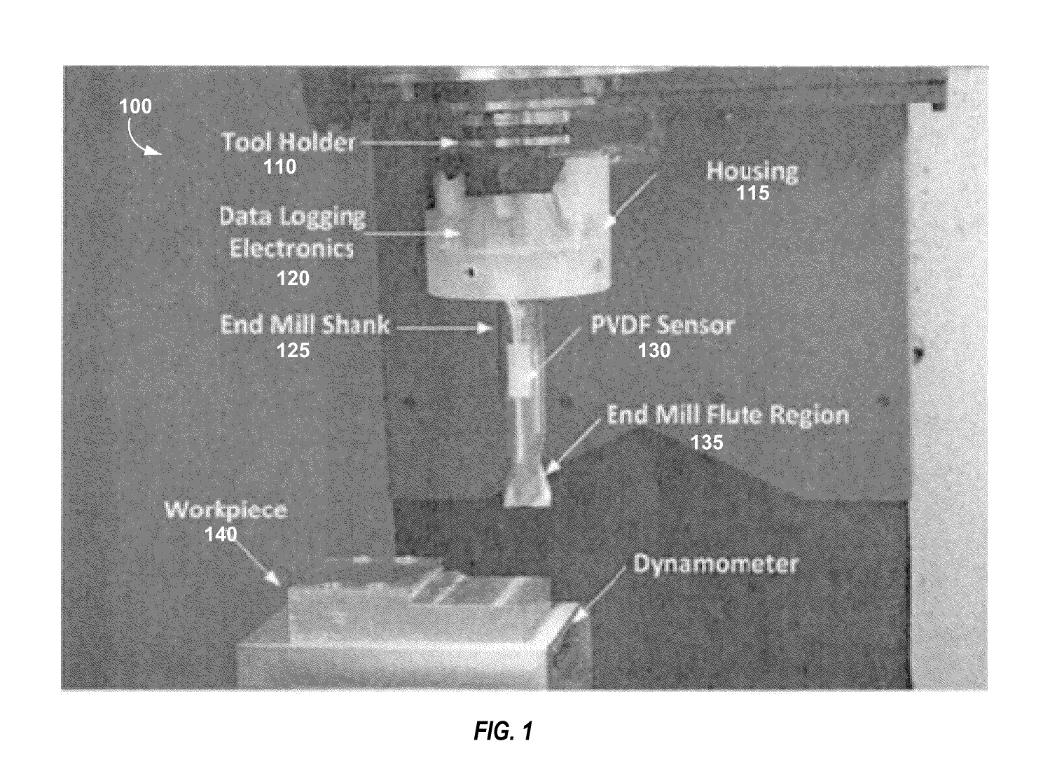

Moving to FIG. 1, an exemplary force measurement system 100 is shown. In one embodiment, the PVDF sensor(s) 130 mounted on the end mill shank 125 are wired to the signal conditioning and data logging electronics 120 (i.e., a processing unit). According to one embodiment, the signal conditioning and data logging electronics 120 comprise an on-board charge amplifier, an anti-aliasing filter, an embedded microcontroller unit (MCU) or processing medium, and an on-board Secure Digital (SD) card or other digital storage medium. As will be understood, the embodiment shown in FIG. 1 is intended for discussion purposes and is intended to be nonlimiting. As shown in FIG. 1, the signal conditioning and data logging electronics are mounted on the tool holder 110 in a polyurethane housing 115, which may be built using stereolithography. Further, as previously noted, though not shown in FIG. 1, the signal conditioning and data logging electronics 120 could be implemented wirelessly.

Typically, the cutting forces acting on the end mill flute region 135 will elastically deform the tool. The elastic strain produced in the tool at the location of the PVDF sensor 130 (i.e., the cutting force information) gives rise to electric charges at the electrodes of the PVDF sensor 130 due to the piezoelectric effect. In one embodiment, these charges are converted into voltage signals using the on-board charge amplifier, whose output is passed through the anti-aliasing filter before being sampled by the embedded MCU, which logs the sampled signal into the on-board SD card such that the sampled signal can be further evaluated or processed.

As noted, thin film sensors, particularly Polyvinylidene Fluoride (PVDF) piezoelectric sensors, have been proposed as a promising candidate as strain gauges for use in systems and methods for monitoring cutting forces in peripheral end milling. But, the transverse sensitivity of such PVDF sensors is higher than that of typical metal foil strain gauges, thereby making it more difficult to isolate a particular strain component or a deformation mode when the host structure (e.g., the end mill shank 125) is under complex loading. Further, PVDF sensors are sensitive to changes in ambient temperature due to the pyroelectric effect. Accordingly, the presently-disclosed systems and methods may employ a preconfigured PVDF sensor rosette design. For example, in one embodiment, a temperature-compensated PVDF sensor rosette design for isolating one or more specific strain components (e.g., bending strain, shear strain, axial strain, etc.) and deformation modes of interest may be incorporated. In one embodiment, a PVDF sensor rosette may be incorporated that can be used to identify all three in-plane strain components (i.e., bending, shear, axial) in a general strain field. In one embodiment, three PVDF rosettes are used to decouple all three strain components.

Additionally, in one embodiment, a PVDF rosette for isolation of bending strain (i.e., a bending strain rosette) may be utilized, which may eliminate the sensitivity of the PVDF sensors to axial and shear strains, thus isolating bending strain. Typically, a bending strain rosette comprises a plurality of sensors. In one embodiment, a bending strain rosette comprises four sensors, which may be applicable for any host structure (e.g., rectangular beam, circular cross-section beam, etc.), as will be discussed. Further, in one embodiment, a PVDF rosette for isolation of shear strain (i.e., shear strain rosette) may be utilized, which may isolate shear strain in a host structure subjected to complex loading. Finally, in one embodiment, a PVDF rosette for isolation of axial strain (i.e., axial strain rosette) may be utilized, which may isolate axial strain applied to the host structure. Both the bending strain rosette and axial strain rosette will be discussed further.

Additionally, the disclosed systems and methods may be utilized for monitoring cutting torque in an end milling process, according to one embodiment. In one embodiment, PVDF sensor(s) 130 mounted on the end mill shank 125 may receive cutting force information relating to dynamic shear strain produced in the end mill flute region 135 during the cutting process. In one embodiment, the PVDF sensor(s) 130 may be a preconfigured PVDF sensor rosette that is insensitive to various forces (e.g., the pyroelectric effect of a PVDF sensor or various strain components such as bending strain or thermal strain). A physics-based model included in the presently-disclosed systems and methods may be used to relate the received cutting force information to dynamic milling torque. Additional information relating to monitoring cutting torque can be found in “PVDF Sensor-Based Monitoring of Milling Torque,” by Lei Ma, Shreyes N. Melkote, and James B. Castle and published in the International Journal of Advanced Manufacturing Technology, DOI: 10.1007/s00170-013-5410-2, originally published 27 Oct. 2013, which is incorporated by reference in its entirety.

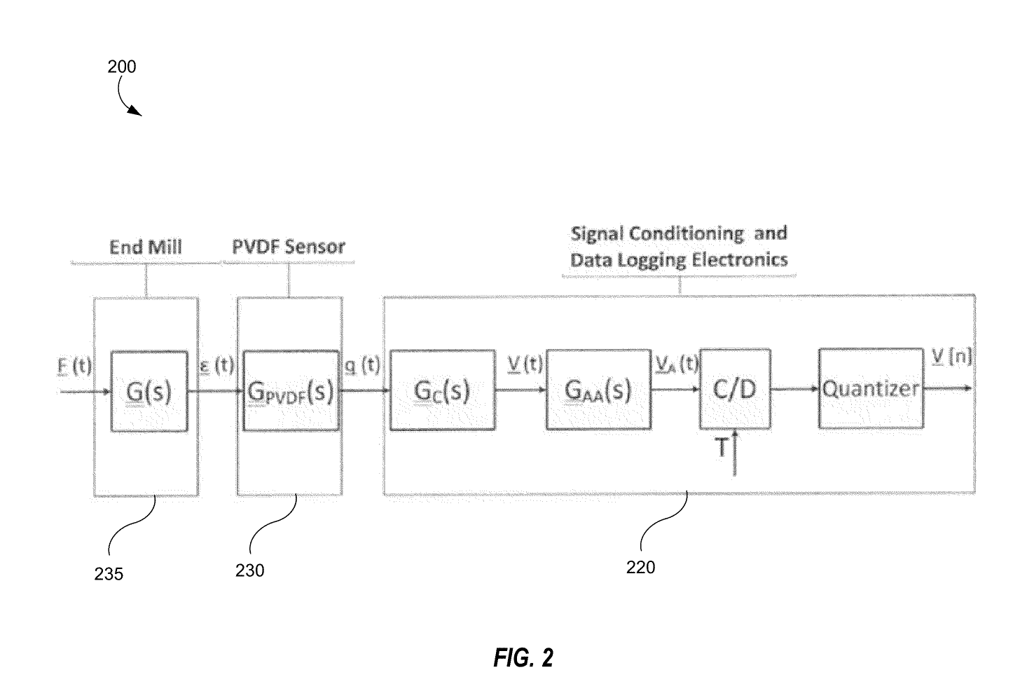

FIG. 2 is a block diagram 200 illustrating the signal flow of an exemplary force measurement system 100, according to one embodiment. As shown in the signal flow block diagram 200, the cutting force component vector is denoted by F(t). In one embodiment, the cutting force component vector is associated with cutting force in formation. As further shown in FIG. 2, strain response at the PVDF sensor location 230 is denoted by ε(t). The charges generated at the electrodes of the PVDF sensor 230 are denoted by q(t), and the voltage signal produced by the charge amplifier is denoted by V(t), as shown in the FIG. 2. Further, as shown in the FIG. 2, the voltage signal output by the anti-aliasing filter is denoted by V_{A}(t), and the digital voltage samples collected by the data logging unit are denoted by V[n]. Finally, as shown in the FIG. 2, the sampling period is denoted by T. For purposes of the FIG. 2, the single underline notation used for the variables denotes that there are multiple force components (i.e., Fₓ, F_{y}, and F_{z}) and multiple PVDF sensors (e.g., ε₁, ε₂, ε₃, etc.) involved. Accordingly, as shown in the FIG. 2, the double underline notation is used to denote the transfer function blocks (i.e., G(s), G_{AA}(s), G_{C}(s), G_{PVDF}(s)), which are, in general, matrices.

Typically, to accurately measure the input cutting force signals (i.e., the cutting force information), the transfer function of each block in the signal flow chain of the block diagram 200 needs to be modeled such that the overall transfer function between the discrete time voltage sample and the continuous time series forces can be found.

Generally, digital voltage samples are acquired by an MCU and stored for further processing. In one embodiment, processing includes utilizing various physics-based models included in the disclosed systems and methods to generate cutting force data from the digital voltage samples. As discussed, cutting force data can be used to relate the cutting force information to the actual end milling cutting forces. As further discussed, in certain embodiments, cutting force data can be used for detecting chatter, monitoring tool wear, detecting tool breakage, etc. As noted, in one embodiment, suitable processing algorithms based on received cutting force information and generated cutting force data can be devised to detect chatter, tool wear, or tool breakage. Additionally, various other algorithms based on received cutting force information and cutting force data generated by the presently-disclosed systems and methods can be generated, as will be understood by those of ordinary skill in the art.

### Force Measurement Systems Modeling

### Mechanical Transfer Function Between Cutting Forces and Strain

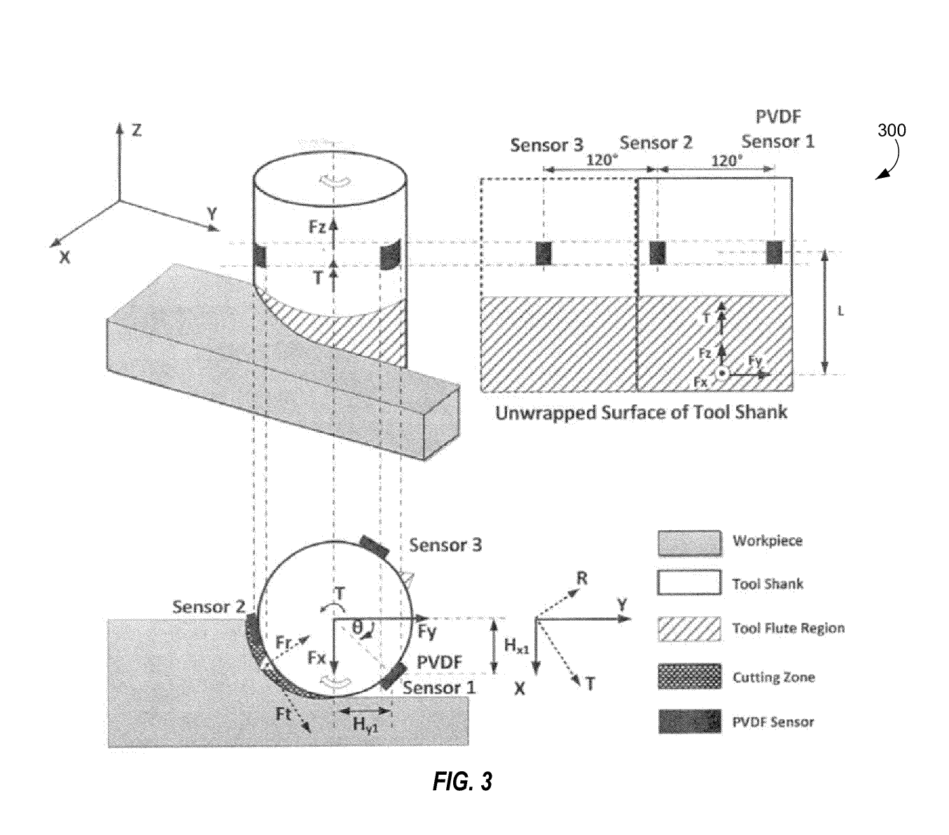

Moving to FIG. 3, an exemplary schematic of PVDF sensor deployment 300 for a force measurement system setup for a peripheral end milling process is shown, according to one embodiment. Generally, to measure the feed and transverse forces in peripheral end milling, at least two PVDF sensors are needed. According to one embodiment, as shown in FIG. 3, a strain gauge rosette design is used that consists of three PVDF sensors mounted 120° apart from each other on the tool shank. As will be appreciated, utilizing more than the minimum required sensors (i.e., two sensors) increases the robustness of the measurement system.

The peripheral end milling process shown in FIG. 3 establishes two major coordinate systems: 1) the machine-centered coordinate system representing the feed (Y), transverse (X), and axial (Z) force directions; and 2) the tool centered coordinate system that corresponds to the tangential (T), radial (R), and axial force (Z) directions. In one embodiment and as described below in the model development, it is assumed that the tangential and radial forces, which are in reality distributed forces, can be approximated by two concentrated loads acting on the tool at a distance equal to half the axial depth of cut. With this assumption, the tool, which is typically subjected to complex loading during cutting, can be treated with simplified loading conditions, namely, biaxial bending in the feed and transverse directions and torsion about the tool axis.

Of these two deformation modes, bending generally is considered to be more critical for the model development as it can cause the tool to be pushed away from or pulled into the workpiece, thereby altering the effective axial and radial depth of cut. Further, for the purpose of the model development of the present embodiment, the shear strain caused by torsion is neglected since the PVDF sensor typically is insensitive to the in-plane shear strain, as will be discussed. Finally, for the purpose of the model development, it is assumed that the tool deformation is such that small strain theory of elasticity is applicable.

Continuing with FIG. 3 and using the FIG. 3 sign convention, treating the end mill as a cantilever beam clamped in the tool holder and assuming the Euler-Bernoulli beam theory applies, the bending strain induced in the tool at the location of the PVDF sensor i (i=1, 2, 3) can be found using bending formula of Eq. (1):

$${ɛ}_{i α} = - \frac{{F}_{y} {LH}_{yi} + {F}_{x} {LH}_{xi}}{{E}_{j} {I}_{xx}} = \frac{64 L ( {F}_{y} {H}_{yi} + {F}_{x} {H}_{xi} )}{{E}_{j} π {D}_{0}^{4}} \\ ( i = 1 , 2 , 3 ) \qquad ( 1 )$$

Accordingly, the transverse strain due to the Poisson effect is shown with Eq. (2):

εᵢₓ=−vᵢε_{iα} (i=1,2,3) (2)

It can be shown that the axial normal strain caused by the axial force F_{z} generally is close to two orders of magnitude smaller than the bending strain obtained from Eq. (1) when the axial and feed forces are comparable in magnitude. Therefore, for the purposes of the model development for one embodiment of the present disclosure, the axial normal strain is not considered.

As the tool shown in FIG. 3 rotates, H_{yi} and Hₓᵢ vary constantly as described by the following Eqs. (3) and (4):

$$\begin{matrix}{H}_{yi} = \frac{{D}_{0}}{2} cos ( θ + {θ}_{i} ) ( i = 1 , 2 , 3 ) & ( 3 ) \\ {H}_{xi} = \frac{{D}_{0}}{2} sin ( θ + {θ}_{i} ) ( i = 1 , 2 , 3 ) & ( 4 )\end{matrix}$$

In Eqs. (3) and (4) above, θ₁=0°, θ₂=120°, and θ₃=240°. Combining Eqs. (1), (3), and (4), the bending strain at the i^{th} sensor i is shown by Eq. (5):

$${ɛ}_{i α} = - \frac{32 L ( {F}_{y} cos ( θ + {θ}_{i} ) + {F}_{x} sin ( θ + {θ}_{i} ) )}{{E}_{i} π {D}_{0}^{3}} \\ ( i = 1 , 2 , 3 ) \qquad ( 5 )$$

In Eq. (5), θ is given by:

θ=ω₀t+φ₀ (6)

Further, in Eq. (6), ω₀ and φ₀ are the angular velocity of the end mill and the initial angular position(s) of the sensor(s), respectively.

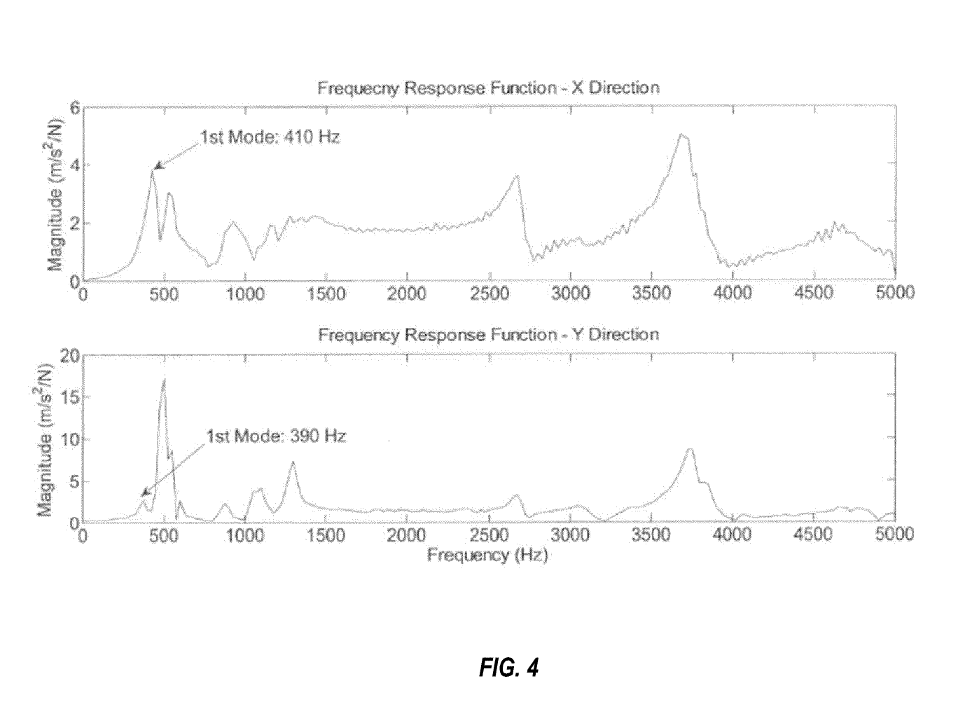

In the embodiment and model described above, a static model is used to relate the strain at the PVDF sensor location to the dynamic cutting forces. As will be appreciated, the static model generally is sufficient when the tooth passing frequency is below the lowest natural frequency of the cutting tool/spindle/machine tool system. In developing the model, a stationary impact hammer test was performed to find the lowest natural frequency of the force measurement system (as shown in FIG. 1) in the feed (Y) and transverse directions (X). The test was repeated 25 times for each direction and a least-squares-based H₁ algorithm was used to find the frequency response function (FRF). FIG. 4 shows the accelerance form of the FRF. As shown in the FIG. 4 FRF, the X and Y directions both have modes that are nearby (410 Hz and 390 Hz, respectively), thereby justifying the assumption that a stationary (i.e., not rotating) spindle modal test is sufficient in the embodiment and model. Accordingly, a static model is applicable as long as the excitation frequency due to the cutting forces is below 390 Hz. If the excitation frequency due to the cutting forces is greater than 390 Hz, a frequency-dependent transfer function is necessary to relate the strain response to the cutting forces.

### Modeling of PVDF Sensor Strain-Charge Relation

In one embodiment, the PVDF sensors are bonded to the tool shank using commercially available adhesives (e.g., epoxy glue, double-sided tape, etc.), thus necessitating the consideration of the potential impact of shear lag on the sensor signal. For purposes of the embodiment and model described above, the possible influence of shear lag on the measurement is accounted for by assuming that only a certain amount of axial strain is transmitted to the sensor through the adhesive. Therefore, the axial strain induced in sensor i is given by Eq. (7):

εᵢₚ=κε_{id} (i=1,2,3) (7)

where

0≦κ≦1 (8)

Typically, it is assumed that κ=1.

To relate the axial strain induced in the sensor to the electric charge generated in the PVDF sensor electrodes, the constitutive model of the PVDF sensor generally needs to be considered. Because the axial strains considered are typically small, the linear constitutive model given in Eq. (9) is generally sufficient:

$$[ \begin{matrix}D \\ ɛ\end{matrix} ] = [ \begin{matrix}{e}^{σ} & d \\ {d}^{T} & {s}^{E}\end{matrix} ] [ \begin{matrix}E \\ σ\end{matrix} ] \qquad ( 9 )$$

The constitutive equations of the PVDF sensor in Eq. (9) are referred to as the strain-charge form, though various alternative constitutive equations are available. In Eq. (9), the vogit notations of the stress vector σ and the strain vector ε are used, s^{E} is the 6×6 elastic compliance matrix, and the piezoelectric stress coefficient matrix d has the following form:

$$d = [ \begin{matrix}0 & 0 & 0 & 0 & {d}_{15} & 0 \\ 0 & 0 & 0 & {d}_{24} & 0 & 0 \\ {d}_{31} & {d}_{32} & {d}_{33} & 0 & 0 & 0\end{matrix} ] \qquad ( 10 )$$

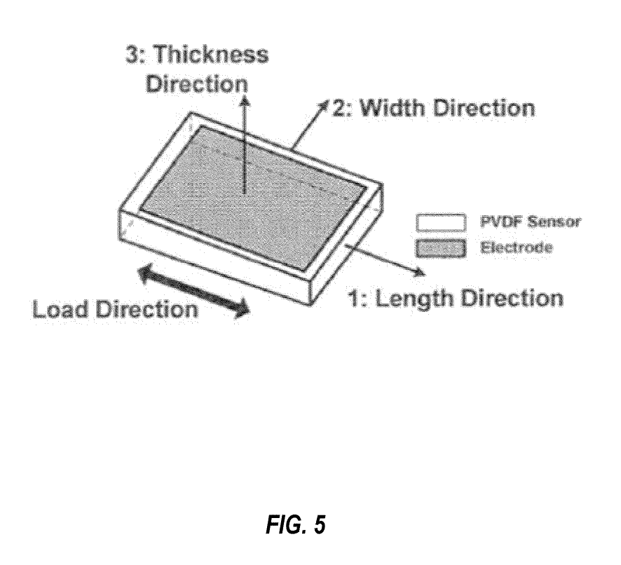

As represented in Eq. (10), the index i in dᵢⱼ references the electric axis while index j refers to the mechanical axis (i.e., it relates the electric displacement generated in the i^{th} direction to the mechanical stress applied in the j^{th} direction). For a thin film piezoelectric sheet, similar to that shown in FIG. 5, the poling typically is in the thickness direction, which is denoted as axis 3. As further shown in FIG. 5, axes 1 and 2 refer to the two in-plane axes (i.e., the length direction and the width direction, respectively). Further, when the PVDF piezoelectric element is used as a sensor, there is no externally applied electric filed (i.e., E=0). Consequently,

$$[ \begin{matrix}{D}_{1} \\ {D}_{2} \\ {D}_{3}\end{matrix} ] = [ \begin{matrix}0 & 0 & 0 & 0 & {d}_{15} & 0 \\ 0 & 0 & 0 & {d}_{24} & 0 & 0 \\ {d}_{31} & {d}_{32} & {d}_{33} & 0 & 0 & 0\end{matrix} ] [ \begin{matrix}{σ}_{1} \\ {σ}_{2} \\ {σ}_{3} \\ {σ}_{4} \\ {σ}_{5} \\ {σ}_{6}\end{matrix} ] \qquad ( 11 )$$

As illustrated by Eq. (11), the in-plane shear stress, represented by σ₆, does not contribute to the electric displacement component because dₖ₆ (k=1, 2, 3) is zero. Accordingly, it is reasonable to deduce that the PDVF sensor is not sensitive to in-place shear strains when the PDVF sensor is mounted properly with respect to the tool (i.e., when axis 1 of the PDVF sensor is parallel to the end mill axis).

To compute the electric charges generated by the mechanical strains, the electric displacements need to be integrated over the electrode areas whose surface normals are parallel to the electric displacement which, according to one embodiment, is shown in Eq. (12):

q=∫D^{T}dA=∫(D₁dA₁+D₂dA₂+D₃dA₃) (12)

Generally, after being poled, the PVDF element can be treated as an orthotropic material with the symmetry axes coincident with the geometric axes shown in FIG. 5. Because of the small thickness of a PVDF sensor, it generally can be assumed that the sensor is in a state of plane stress, (i.e., σ₃=σ₄=σ₅=0. Accordingly, the constitutive equations of the PVDF sensor material in a plane stress state (with externally applied electric field E=0) can be written as follows:

$$[ \begin{matrix}{ɛ}_{1} \\ {ɛ}_{2} \\ {ɛ}_{6}\end{matrix} ] = [ \begin{matrix}\frac{1}{{E}_{1}} & \frac{- {v}_{21}}{{E}_{2}} & 0 \\ \frac{- {v}_{12}}{{E}_{1}} & \frac{1}{{E}_{2}} & 0 \\ 0 & 0 & \frac{1}{{E}_{6}}\end{matrix} ] [ \begin{matrix}{σ}_{1} \\ {σ}_{2} \\ {σ}_{6}\end{matrix} ] \qquad ( 13 )$$

As shown in Eq. (13), vᵢₘ is the Poisson's ration between axes l and m (i.e., the contribution to the normal axial strain along axis m by the normal stress along axis l). Due to symmetry, v₂₁/E₂=v₁₂/E₁.

Using Eq. (7) provides the following:

εᵢ₁=κε_{iα}

εᵢ₂=−vᵢκε_{iα} (i=1,2,3) (14)

Further, combing Eqs. (13) and (14), allows for the solving of σ₁ and σ₂ as shown by Eqs. (15) and (16):

$$\begin{matrix}{σ}_{i 1} = \frac{{E}_{1} {κɛ}_{i α} ( 1 - {v}_{21} {v}_{t} )}{1 - {v}_{21} {v}_{12}} ( i = 1 , 2 , 3 ) \\ and & ( 15 ) \\ {σ}_{i 2} = \frac{{E}_{2} {κɛ}_{i α} ( 1 - {v}_{12} {v}_{t} )}{1 - {v}_{21} {v}_{12}} ( i = 1 , 2 , 3 ) & ( 16 )\end{matrix}$$

By combining Eqs. (5), (11), (15), and (16), and integrating according to Eq. (12), the total charge generated in the electrode of the PVDF sensor is given by Eq. (17) as follows:

$${q}_{i} = - \frac{32 {LA}_{i}}{{E}_{i} π {D}_{0}^{3}} \frac{κ}{2 α ( 1 - {v}_{21} {v}_{12} )} [ {d}_{31} {E}_{1} ( 1 - {v}_{21} {v}_{t} ) + {d}_{32} {E}_{2} ( {v}_{12} - {v}_{t} ) ] \\ [ {F}_{y} ( sin ( θ + {θ}_{i} + α ) - sin ( θ + {θ}_{i} - α ) ) - {F}_{x} ( cos ( θ + {θ}_{i} + α ) - cos ( θ + {θ}_{i} - α ) ) ] ( i = 1 , 2 , 3 ) \qquad ( 17 )$$

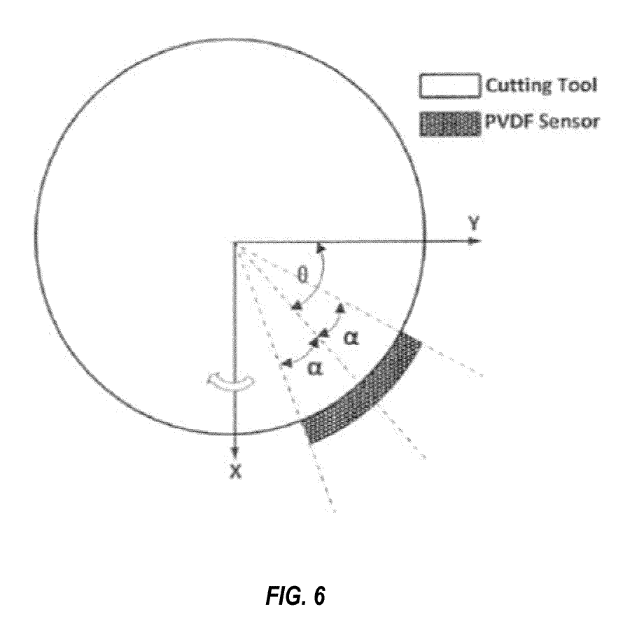

As shown in Eq. (17), A₃ is the area of the electrode layer in the PVDF sensor. Further, as α approaches zero (as is shown in FIG. 6),

$$\begin{matrix}{lim}_{α \to 0} \frac{sin ( θ + {θ}_{i} + α ) - sin ( θ + {θ}_{i} - α )}{2 α} = cos ( θ + {θ}_{i} ) \\ and & ( 18 ) \\ {lim}_{α \to 0} - \frac{cos ( θ + {θ}_{i} + α ) - cos ( θ + {θ}_{i} - α )}{2 α} = sin ( θ + {θ}_{i} ) & ( 19 )\end{matrix}$$

which implies that when the sensor is small enough, the strain produced in the PVDF sensors can be assumed to be uniform. When materials have similar Poisson's ratios (e.g., in the presently-described embodiment, vₜ≈0.24, v₁₂≈v₂₁≈0.35, E₁≈E₂):

(v₁₂−vₜ)<<(1−v₂₁vₜ) (20)

For the PVDF sensor, d₃₂<<d₃₁ (in the presently-described embodiment, d₃₂≈10%-16% of d₃₁). Therefore, the term d₃₂E₂ (i.e., v₁₂−vₜ) can from Eq. (20) without any loss of accuracy. Accordingly, Eq. (17) can be simplified to:

$${q}_{i} = - \frac{32 {LA}_{y}}{{E}_{t} π {D}_{0}^{3}} \frac{κ {d}_{31} {E}_{1} ( 1 - {v}_{21} {v}_{1} )}{1 - {v}_{21} {v}_{12}} [ {F}_{y} \frac{sin ( θ + {θ}_{i} + α ) - sin ( θ + {θ}_{i} - α )}{2 α} - {F}_{x} \frac{cos ( θ + {θ}_{1} + α ) - cos ( θ + {θ}_{i} - α )}{2 α} ] ; ( i = 1 , 2 , 3 ) \qquad ( 21 )$$

Of note, depending on the relative magnitudes of v₁₂ and vₜ, the term dropped from Eq. (17) can either add to or subtract from the overall sensitivity of the PVDF sensor to the cutting forces. As will be understood and appreciated, the motivation for performing the foregoing numerical simplification is to rid Eq. (17) from its dependence on d₃₂, which may be of practical significance when the exact value of d₃₂ is not known. It will be appreciated that because the Possion's ratio of any material typically is constrained in the range [0, 0.5], it is likely that Eq. (20) will hold true even where alternative materials are used. In the case of other piezoelectric materials, however, d₃₂<<d₃₁ generally does not hold true. For example, in the case of Lead Zirconate Titanate (PZT), d₃₂ is very close to d₃₁. As will be appreciated, in such instances, Eq. (17) must be used.

### Modeling of Signal Conditioning Circuitry

Before the sensor signal can be sampled by a data logging system, it is generally necessary to transform electric charges generated in the electrodes of the PVDF sensor into a voltage signal via a charge amplifier and subsequently filter the voltage signal so that any frequency content beyond the Nyquist frequency is sufficiently attenuated. Charge amplifiers are well known to those of skill in the art. For the anti-aliasing filter of the presently-disclosed embodiment, a fourth-order Butterworth filter with a cut-off frequency of 400 Hz was designed so that at least 30 dB attenuation is achieved at 1 KHz or higher. As will be understood, the transfer function of the signal conditioning circuitry can be determined through Laplace domain circuit analysis. In the pass band, the amplitude of the voltage signal can be calculated as

$${V}_{i} = - \frac{{q}_{i}}{{C}_{P}} ; ( i = 1 , 2 , 3 ) \qquad ( 22 )$$

where C_{F} is the capacitance of the capacitor in the feedback loop of the charge amplifier and Vᵢ is the voltage signal generated between the two electrodes of the i^{th} PVDF sensor.

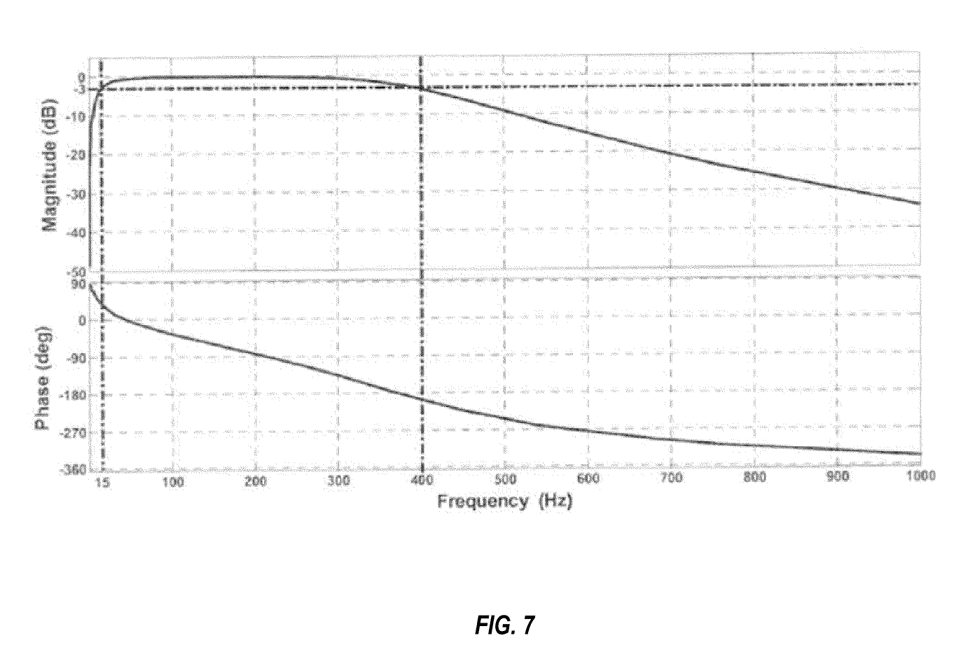

FIG. 7 illustrates the Bode plot of the transfer function of the signal conditioning circuitry (i.e., charge amplifier and Butterworth anti-aliasing filter). As shown in FIG. 7, the low-frequency content of the signal (i.e., <15 Hz) is attenuated by the signal conditioning circuitry. Further, the phase of the input signal is distorted since the phase response of the signal conditioning circuitry is slightly nonlinear, as shown in FIG. 7. Accordingly, it is anticipated that discrete voltage samples collected by a data logging unit will not capture exactly the magnitude and shape of the cutting force.

### Determination of Cutting Force from PVDF Sensor Signals

By combining Eqs. (21) and (22), Eq. (23), which yields three equations containing two unknowns, may be obtained:

$$[ \begin{matrix}{V}_{1} \\ {V}_{2} \\ {V}_{3}\end{matrix} ] = [ \begin{matrix}{A}_{11} ( θ ) & {A}_{12} ( θ ) \\ {A}_{21} ( θ ) & {A}_{22} ( θ ) \\ {A}_{31} ( θ ) & {A}_{32} ( θ )\end{matrix} ] [ \begin{matrix}{F}_{x} \\ {F}_{y}\end{matrix} ] \qquad ( 23 )$$

A least squares approach may be utilized to solve for both Fₓ and F_{y}. Alternatively, θ may be treated as an unknown in which case it is possible to solve the system of non-linear equations for Fₓ, F_{y}, and θ.

### Experimental Verification

The presently-disclosed embodiment of the proposed force measurement system was verified by performing end milling experiments on an Okuma MILLAC 44V CNC milling machine as shown in FIG. 1. The workpiece materials 140 were Aluminum 7050-T7451 (AL7050) and AISI 1018 Steel (S1018). A 25.4 diameter two-flute tungsten carbide square end mill with a 30-degree helix angle was used. No cutting fluid was utilized in the experiments. Additional cutting conditions are listed in Table 1, below:

TABLE 1
Cutting conditions for experimental tests

| | | | | | | Experimen- |
|---|---|---|---|---|---|---|
| | Spindle | Immer- | Depth | Feed per | | tally |
| Test | Speed | sion | of Cut | Tooth | Workpiece | Obtained Kₛ |
| No. | (rpm) | Ratio | (mm) | (mm) | Material | (mV/N) |
| 1 | 750 | 50% | 2.54 | 0.0508 | AL7050 | 3.90 |
| 2 | 900 | 50% | 2.54 | 0.0508 | AL7050 | 3.90 |
| 3 | 1050 | 25% | 2.54 | 0.0635 | AL7050 | 3.64 |
| 4 | 1200 | 25% | 2.54 | 0.0508 | AL7050 | 3.83 |
| 5 | 1500 | 50% | 2.54 | 0.0508 | AL7050 | 3.83 |
| 6 | 1650 | 50% | 2.54 | 0.0508 | AL7050 | 3.83 |
| 7 | 1800 | 50% | 2.54 | 0.0508 | AL7050 | 3.83 |
| 8 | 1950 | 50% | 2.54 | 0.0508 | AL7050 | 3.83 |
| 9 | 2100 | 50% | 2.54 | 0.0508 | AL7050 | 3.83 |
| 10 | 2250 | 25% | 2.54 | 0.0508 | AL7050 | 3.83 |
| 11 | 2400 | 30% | 2.54 | 0.0508 | AL7050 | 3.83 |
| 12 | 1050 | 25% | 1.27 | 0.0254 | S 1018 | 3.75 |
| 13 | 1200 | 25% | 1.27 | 0.0254 | S 1018 | 3.75 |
| 14 | 1200 | 38% | 1.27 | 0.0254 | S 1018 | 3.75 |
| 15 | 1350 | 25% | 1.27 | 0.0254 | S 1018 | 3.75 |
| 16 | 1500 | 25% | 1.27 | 0.0254 | S 1018 | 3.75 |
| 17 | 1650 | 25% | 1.27 | 0.0254 | S 1018 | 3.75 |
| 18 | 1800 | 25% | 1.27 | 0.0254 | S 1018 | 3.75 |

In addition to the PVDF sensor signal measurement, a 3-component piezoelectric platform dynamometer (Kistler 9257B) was used to measure all three cutting force components produced in the machining tests. This data was used to validate the PVDF strain sensor measurements, as will be described later. A NI DAQ board was used to collect force data from the dynamometer at a rate of 10,000 Hz per channel, while the in situ data-logging device was programmed to sample the three PVDF sensors mounted on the end mill shank at a rate of 2,000 Hz per channel.

### Calibration of the PVDF Sensor Signal

Typically, the exact values of the constraints in Eq. (21) are unknown. For example, the Young's modulus of the tool material (Eₜ) and the piezoelectric stress coefficient (d₃₁) of the PVDF sensors may not be precisely known. In cases where only rough estimates are available, the PVDF sensor signal generally must be calibrated against a reliable signal. For example, the PVDF sensor signal may be calibrated against the dynamometer force signal. Accordingly, to facilitate the calibration, the quantity Kₛ may be defined as follows (see Eqs. (21) and (22)):

$${K}_{s} = \frac{32 {LA}_{3}}{{E}_{t} π {D}_{0}^{3}} \frac{κ {d}_{31} {E}_{1} ( 1 - {v}_{21} {v}_{t} )}{1 - {v}_{21} {v}_{12}} \frac{1}{2 α {C}_{F}} \qquad ( 24 )$$

Accordingly, Eq. (22) may be rewritten as:

Vₜ=Kₛ[Fₛ(sin(θ+θᵢ+α)−sin(θ+θᵢ−α))−Fₛ(cos(θ+θᵢ+α)−cos(θ+θᵢ−α))] (25)

If the initial angular position of the sensor (i.e., φ₀) and the angular velocity of the tool (i.e., ω₀) are known, the PVDF sensor can be calibrated against the dynamometer force signal by finding the scaling factor Kₛ. When Eq. (20) or d₃₂<<d₃₁ does not hold, Kₛ may be defined as:

$${K}_{s} = \frac{32 {LA}_{5}}{{E}_{t} π {D}_{0}^{3}} \frac{κ [ {d}_{31} {E}_{1} ( 1 - {v}_{21} {v}_{t} ) ++ {d}_{32} {E}_{2} ( {v}_{12} - {v}_{t} ) ]}{1 - {v}_{21} {v}_{12}} \frac{1}{2 α {C}_{F}} \qquad ( 26 )$$

When defining Kₛ as in Eq. (26), Eq. (25) remains valid. Table 1 lists values of Kₛ obtained from calibration against the dynamometer force signal. For the purpose of validation, Kₛ is calculated from the estimated values of the material constants listed in Table 2, below:

TABLE 2
Estimation of Ks

| E₁ | 600 | GPa |
|---|---|---|
| E₁, E₂ | 5 | GPa [35] |
| ν₁ | 0.35 | |
| ν₂₁, ν₁₂ | 0.24 | |
| d₃₁ | 21E−12 | C/N [37] |
| κ | 1 | |
| Estimated K_{S} | 5.67 | mV/N |

As shown in Table 2, the estimated sensitivity (i.e., Kₛ) is 5.67 mV/N, which is equivalent to 80 mV/με for the presently-disclosed embodiment, which is about 4000 times that of a metal foil strain gauge with a gage factor of two and an excitation voltage of 10V.

### Validation Results

Validation of the PVDF sensor-based force measurement system is performed using the two approaches. First, a Backward Comparison is undertaken in which the independently-measured dynamometer force signal is taken as the true force signal, which is then fed into the measurement system (see FIG. 2). The output of the system, called the reference signal, is the signal expected from the PVDF sensors. If the proposed models for the force measurement system are valid, the reference signal should match the magnitude and shape of the in-situ-measured PVDF sensor signal. Second, a Forward Comparison is undertaken, which involves comparing the dynamometer force signal directly with the force signal back calculated from the in-situ-measured PVDF sensor signal using Eq. (23).

### Backward Comparison

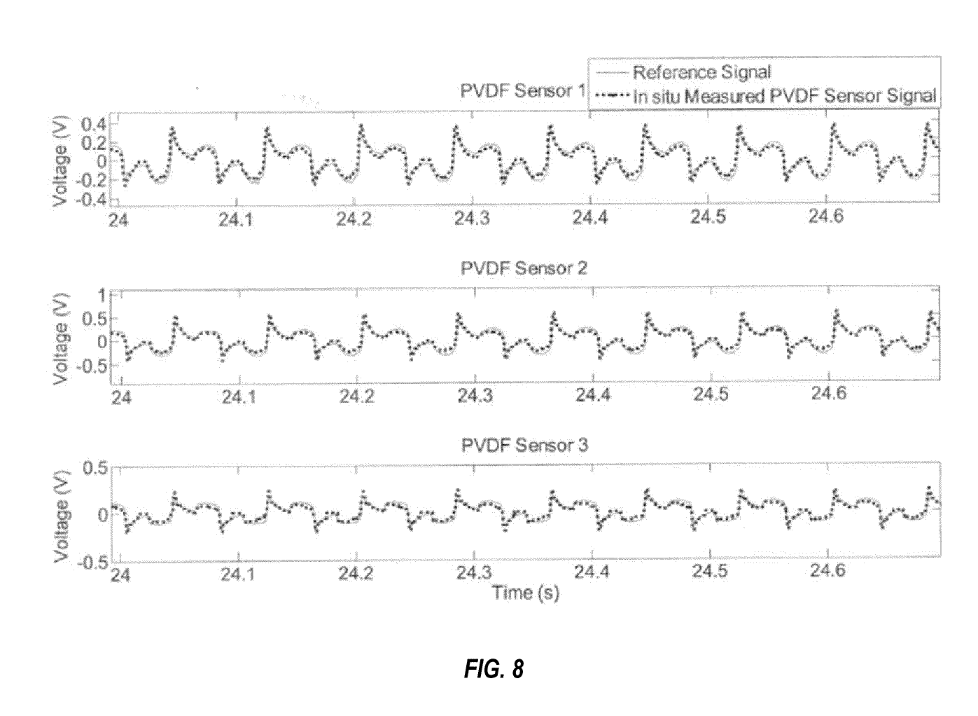

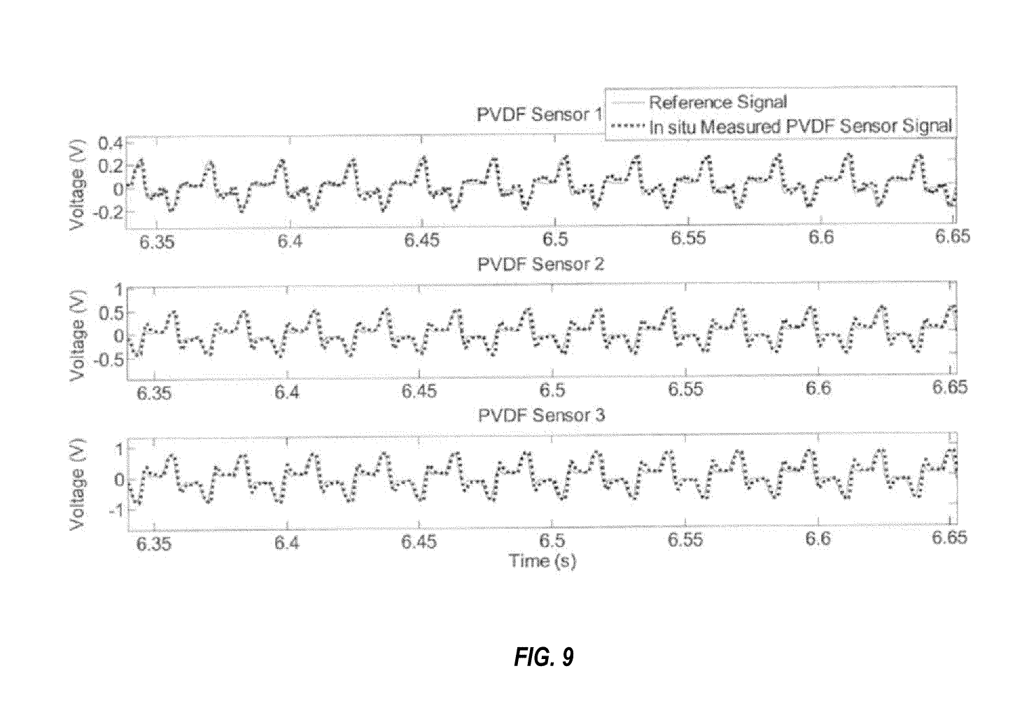

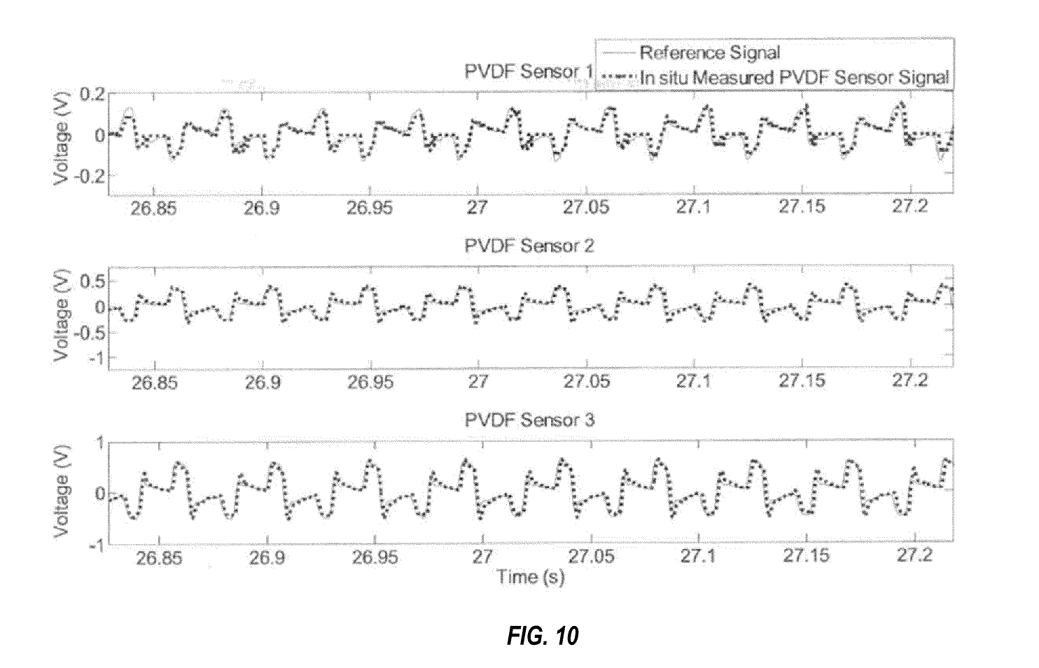

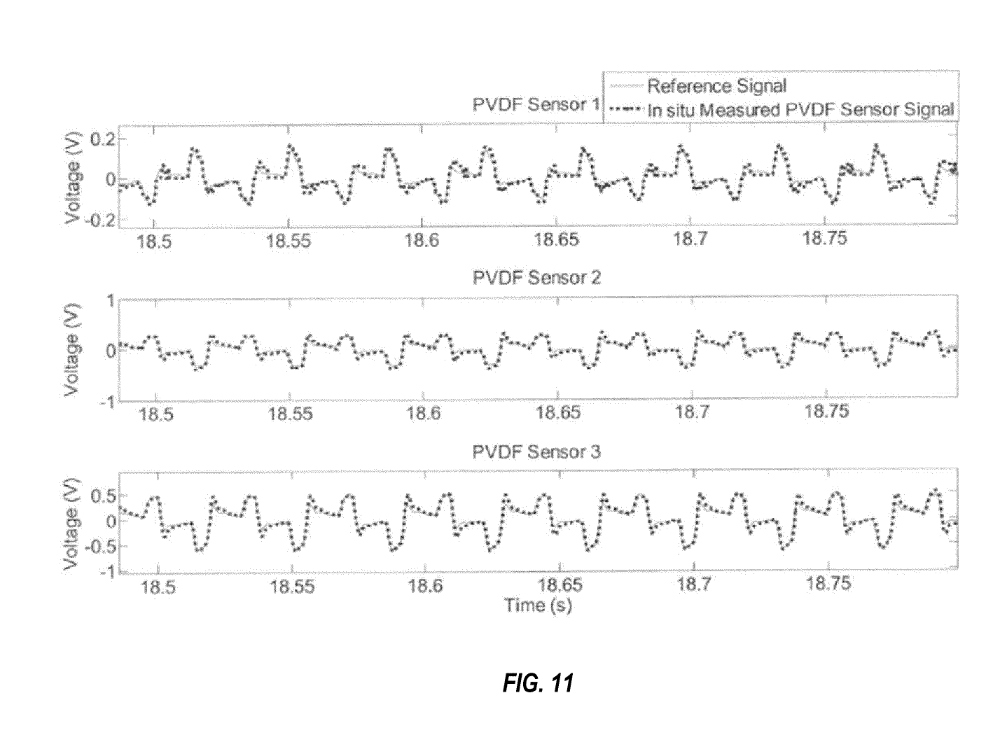

Representative results from a backward comparison are shown in FIGS. 8-11. As is seen in FIGS. 8-11, there is close agreement in both the shape and magnitude of the reference signal and the in-situ-measured PVDF sensor signal, which validates the presently-disclosed embodiment and models of the measurement system. Further, the scaling coefficient Kₛ (listed in Table 1) is largely unchanged across the various cutting conditions and workpiece materials as listed in Table 1. As nothing was assumed about the cutting conditions and the workpiece material in developing the presently-disclosed physics-based model, this is expected. As shown, the in-situ-measured PVDF sensor signal is an attenuated and distorted version of the linear combination of the three cutting force components and should not be confused with a specific force component. In applications where a DC component and the exact shape of a particular force component are not required, in-situ-measured PVDF sensor signals are still useful including examples such as chatter detection, tool wear monitoring, and tool breakage detection.

Further, experimentally-obtained Kₛ (listed in Table 1) is of the same order of magnitude as the estimated value given in Table 2, although it is approximately 32% smaller. This validates the models represented by Eqs. (21) and (22). It will be appreciated that more reliable values of material constants would yield better agreement between the experimentally-determined and the estimated Kₛ.

### Forward Comparison

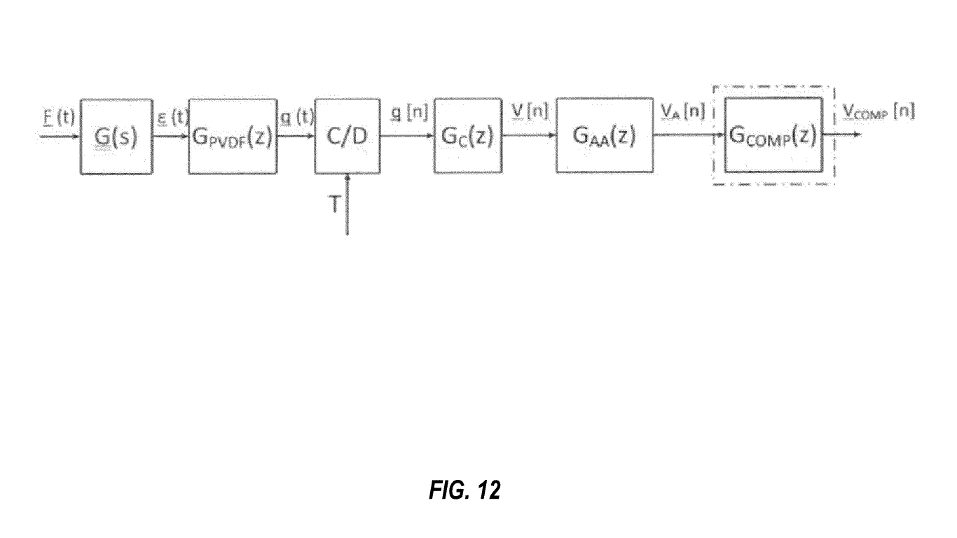

It will be understood and appreciated that in applications where the exact magnitude and shape of force components is required, the in-situ-measured PVDF sensor signal is unlikely to be sufficient. To compensate for the distortion introduced by the signal conditioning circuitry and to recover the original magnitude and shape of the force signal, a discrete Finite Impulse Response (FIR) compensation filter may be introduced as shown in FIG. 12. In one embodiment, and as shown in FIG. 12, it is necessary to discretize the continuous time transfer function of the charge amplifier filter (G_{C}(s)) and the anti-aliasing filter (G_{AA}(s)) into G_{C}(z) and G_{AA}(z), respectively, using the zero-order hold transformation method.

In one embodiment, it is possible to define:

G(z)=G_{C}(z)G_{AA}(z) (27)

Further, it is possible to allow g(n) to be the inverse z-transform of G(z). Based on these parameters, it is possible to design a least squares inverse FIR filter h(n) such that:

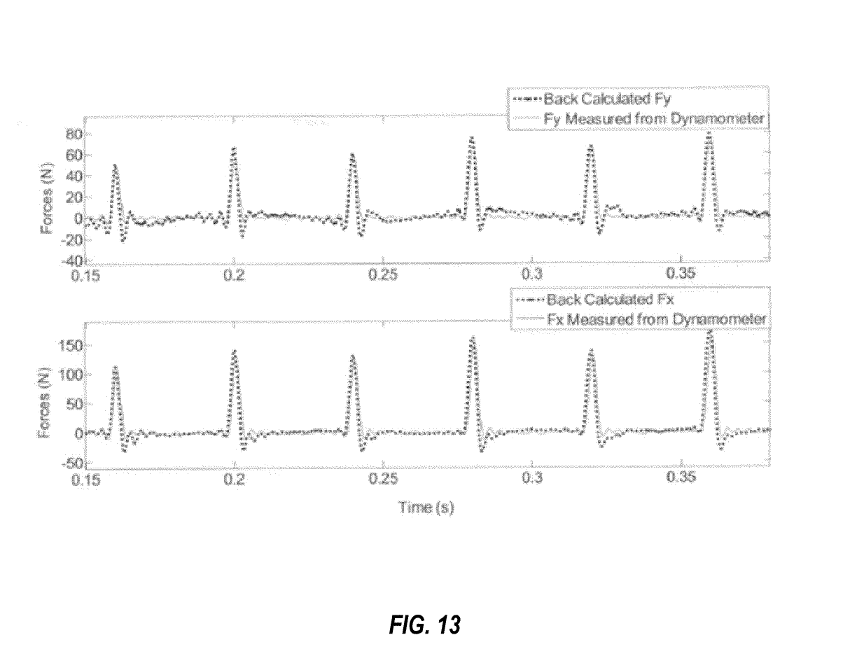

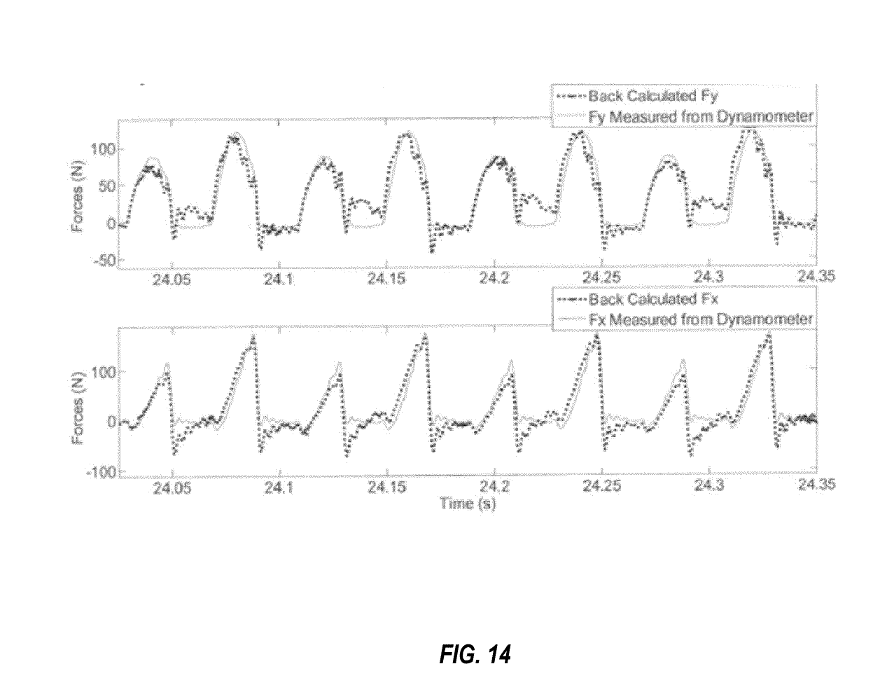

g(n)*h(n)≈δ(n−n_{d}) (28)

where * denotes the convolution operation, δ(n) is the unit impulse function, and n_{d} is the integer delay in the discrete time domain. Accordingly, G_{COMP}(z) is then the z-transformation of h(n). Of note, an inversion of G(z) is not possible as G(z) has a zero at 0 Hz. The forward comparison can then be performed between the force signal calculated from the PVDF sensor signals using Eq. (23) and the independently-measured dynamometer force signal. Representative results for the feed (F_{y}) and transverse (Fₓ) forces are shown in FIGS. 13 and 14.

As shown in FIGS. 13 and 14, the FIR compensation filter helped to restore the PVDF sensor signals to their “reference” form at the expense of extra computation and delay (n_{d} samples) introduced in the discrete time domain. To better compare the force signal calculated from the PVDF sensor signals and the independently-measured dynamometer force signals, the delay is not illustrated in FIGS. 13 and 14. Also, the dynamometer force signal measured from dynamometer was downsampled so that its cutoff frequency matches that of the PVDF sensor signal. Reasonable agreement between the forces back calculated from the PVDF sensor signals and the dynamometer measurements is achieved, except where sharp transitions occur in the force signals (e.g., when the cutter enters/exits the workpiece). The agreement between the two signals is better at the tool entry stage of cutting than in the stable cutting stage. The oscillations observed in the transition region can be explained by the Gibbs phenomenon, which can be suppressed by further increasing the sampling rate of the PVDF sensor-based force measurement system to cover higher order harmonics of the tooth passing frequency. Increasing the signal-to-noise ratio (SNR) of the force measurement system may help in bringing the two signals even closer. For off-line data processing, a FIR filter with optimal delay (i.e., n_{d}) may be found in order to minimize the difference between the two sides of Eq. (28). For on-line applications, however, n_{d} is generally bound by the allowable latency.

### Chatter Detection

A discussed previously, the disclosed systems and methods may comprise various physics-based models that relate PVDF sensor signals to various end milling cutting forces. Generally, PVDF sensors receive information relating to various end milling cutting forces (i.e., cutting force characteristics or cutting force information), and the various physics-based models included in the disclosed systems and methods process the received cutting force characteristics (i.e., information) and generate various cutting force data. In one embodiment, this cutting force data can be used to relate the cutting force characteristics to the actual end milling cutting forces. For example, in one embodiment, a suitable processing algorithm can be devised to detect machining vibrations (i.e., chatter) based on the received cutting force characteristics and generated cutting force data.

In one embodiment, a chatter detection method may be devised using cutting force data as generated by the presently-disclosed systems and methods. For example, a time domain algorithm based on cutting force data can be used for detecting milling chatter and for estimating the dominant chatter frequency. Such an algorithm may be capable of detecting the onset of chatter and distinguishing between chatter and workpiece-geometry-induced transients in the cutting force information. In one embodiment, a chatter detection method may originate from the spectrum estimation of a complex exponentials signal embedded in white noise. Such a method has been shown to be as accurate as Fourier-transform-based methods while also being more computationally efficient.

As will be understood by one of ordinary skill in the art, similar detection systems and methods may be devised using cutting force data as generated by the presently-disclosed systems and methods for monitoring various end milling cutting forces.

Additional information relating to chatter detection can be found in “A Model-Based Computationally Efficient Method for On-Line Detection of Chatter in Milling,” by Lei Ma, Shreyes N. Melkote, and James B. Castle and published in the Journal of Manufacturing Science and Engineering, June 2013, Vol. 135, which is incorporated by reference in its entirety.

### PVDF Sensor Rosettes

### Bending Strain Rosette

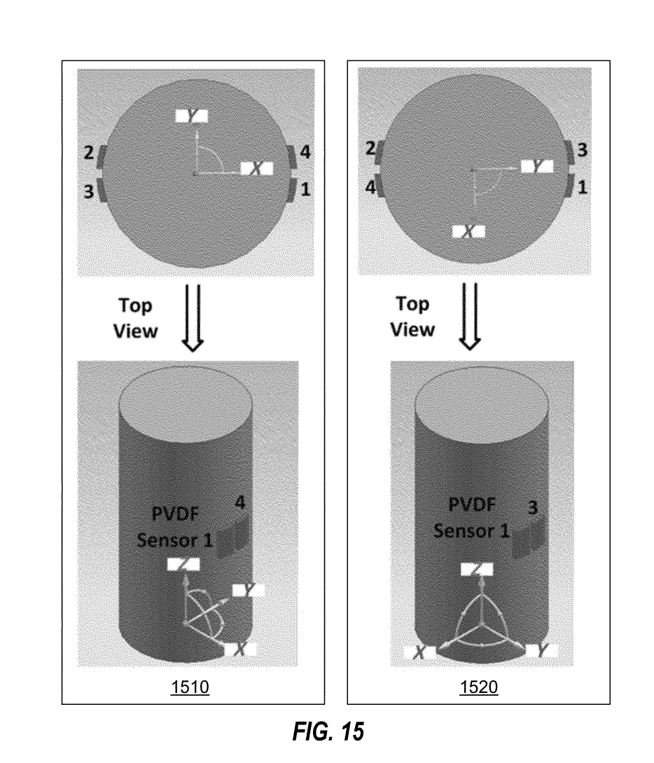

As discussed, in various embodiments, a PVDF rosette for isolation of bending strain (i.e., a bending strain rosette) may be utilized, which may eliminate the sensitivity of the PVDF sensors to axial and shear strains. In particular, a bending strain rosette is applicable for systems and methods for monitoring various end milling cutting forces. Typically, a bending strain rosette comprises a plurality of sensors. In one embodiment, a bending strain rosette comprises four sensors. Generally, a bending strain rosette comprising four sensors is applicable for any host structure where the symmetry between sensors 1 and 3, 2 and 4, 1 and 4, and 2 and 3 is satisfied, as shown in FIG. 15.

In one embodiment, the bending strain in a circular cross-section beam can be measured using the using configurations 1510 or 1520, as shown in FIG. 15. In either case, the configurations measure the bending strain due to flexure about the XZ neutral plane. Typically, configuration 1510 maximizes the temperature compensation performance because the sensors 1 and 2 are close to sensors 4 and 3, respectively. The sensitivity of the rosette in configuration 1510 may be lower because all four sensors (i.e., sensors 1, 2, 3, and 4) are close to the neutral plane. Alternatively, configuration 1520 generally maximizes the overall sensitivity to bending strain while limited temperature compensation since sensors 1 and 2 are far apart from sensors 4 and 3 respectively.

### Shear Strain Rosette

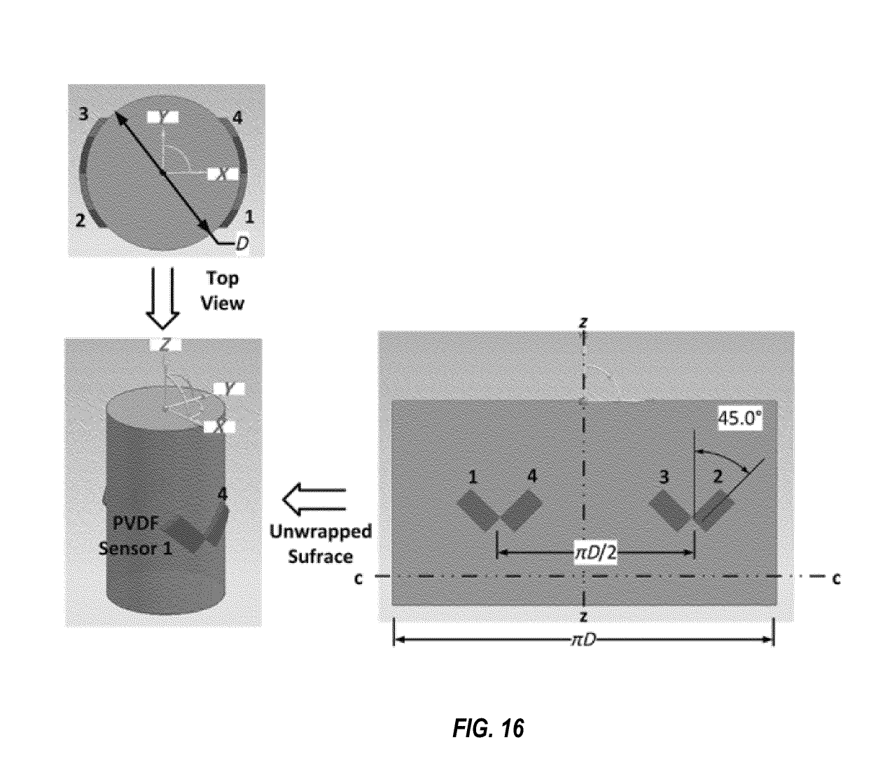

As discussed, in various embodiments, a PVDF rosette for isolation of shear strain (i.e., a shear strain rosette) may be utilized, which may isolate shear strain in a circular shaft subjected to complex loading. Typically, a shear strain rosette comprises a plurality of sensors. In one embodiment, a shear strain rosette comprises four sensors. Generally, while a shear strain rosette comprising four sensors is applicable to a circular shaft, it is likewise applicable for any host structure where the symmetry between sensors 1 and 4, and 2 and 3 is satisfied while the antisymmetry between sensor pairs 1 and 3, and 2 and 4 is maintained, as shown in FIG. 16.

### Axial Strain Rosette

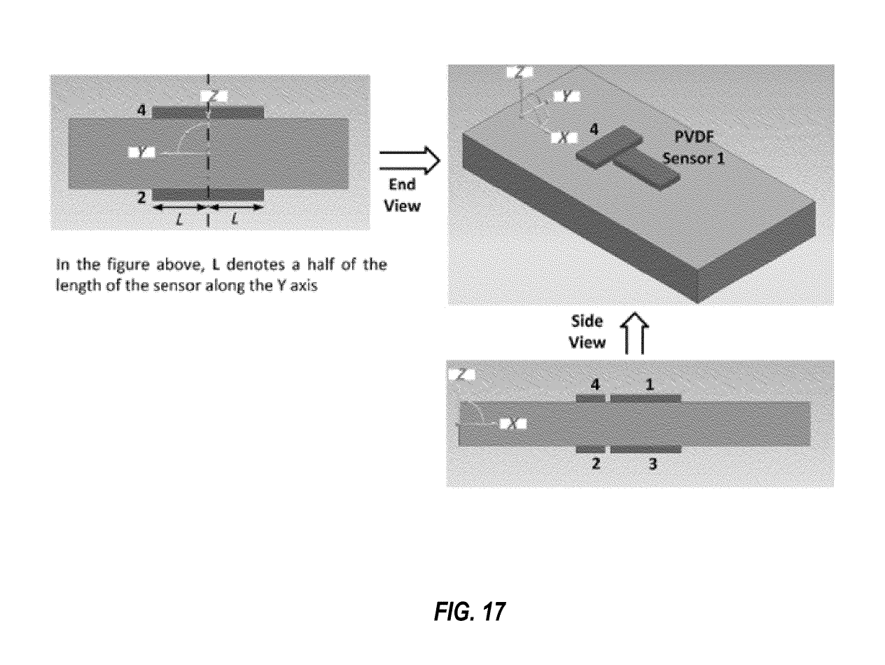

As discussed, in various embodiments, a PVDF rosette for isolation of axial strain (i.e., an axial strain rosette) may be utilized, which may be used to isolate axial strain from other string components (i.e., bending strain, shear strain, thermal strain). Typically, an axial strain rosette comprises a plurality of sensors. In one embodiment, an axial strain rosette comprises four sensors. Generally, an axial strain rosette comprising four sensors is applicable for any host structure where there is symmetry between sensors 1 and 3, and 2 and 4 (e.g., a circular bar and cruciform bar), as shown in FIG. 17.

Additional information relating to sensor rosettes can be found in “Design of Thin-Film Polyvinylidene Fluoride Sensor Rosettes for Isolation of Various Strain Components,” by Lei Ma, Shreyes N. Melkote, John B. Morehouse, James B. Castle, James W. Fonda, and Melissa A. Johnson, and published in the Journal of Intelligent Material Systems and Structures, DOI: 10.1177/1045389X12443597, originally published 6 May 2012, which is incorporated by reference in its entirety.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A method comprising:
generating an electric charge at a sensor in response to force characteristics;
amplifying the electric charge;
filtering the amplified electric charge;
acquiring one or more samples with a processing medium from the amplified electric charge at a predetermined sampling period; and
storing the one or more samples on a storage medium.

2. The method of claim 1, wherein the sensor comprises a strain gauge; wherein the electric charge is amplified with a charge amplifier; and wherein the one or more samples comprise digital samples.

3. The method of claim 1, wherein the force comprises a cutting force; and wherein the amplified electric charge comprises one or more voltage signals.

4. The method of claim 1, wherein the sensor comprises a piezoelectric sensor.

5. The method of claim 4, wherein the piezoelectric sensor comprises a Polyvinylidene Fluoride (PVDF) sensor.

6. The method of claim 3, wherein filtering the one or more voltage signals comprises filtering the one or more voltage signals with a filter; and wherein the filter removes aliasing from the one or more voltage signals.

7. The method of claim 3, wherein the cutting force characteristics comprise one or more of feed force and transverse force.

8. The method of claim 1, wherein the processing medium comprises a microcontroller unit (MCU).

9. A method comprising:
generating an electric charge at a Polyvinylidene Fluoride (PVDF) sensor in response to cutting force characteristics, wherein cutting force characteristics comprise one or more of feed force and transverse force;
amplifying the electric charge with a charge amplifier into one or more voltage signals;
filtering the one or more voltage signals with a filter, wherein the filter removes aliasing from the one or more voltage signals;
acquiring one or more digital voltage samples with a microcontroller unit (MCU) from the one or more voltage signals at a predetermined sampling period; and
storing the one or more digital voltage samples on a digital storage medium.

10. The method of claim 9 further comprising generating cutting force data based on the digital voltage samples, wherein the cutting force data are generated via the MCU.

11. The method of claim 10, wherein generating cutting force data comprises using one or more physics-based models.

12. The method of claim 10, wherein the cutting force data are utilized for relating the cutting force characteristics to end milling cutting forces.

13. A system comprising:
a plurality of strain gauges mounted to a machine, wherein the plurality of strain gauges are configured to generate an electric charge in response to cutting force characteristics; and
a processing unit in communication with the plurality of strain gauges comprising:
a charge amplifier, wherein the charge amplifier is configured to amplify the electric charge into one or more voltage signals;
a filter, wherein the filter is configured to filter the one or more voltage signals;
a microcontroller unit (MCU), wherein the MCU is configured to acquire one or more digital voltage samples from the one or more voltage signals at a predetermined sampling period; and
a digital storage medium, wherein the digital storage medium is configured to store the one or more digital voltage samples for further processing.

14. A system comprising:
a cutting tool comprising an end mill shank and an end mill flute region;
a preconfigured Polyvinylidene Fluoride (PVDF) sensor rosette mounted to the end mill shank, wherein the PVDF sensor rosette is configured to generate an electric charge in response to cutting force characteristics comprising one or more of feed force and transverse force, and wherein the cutting force characteristics are associated with cutting forces acting on the end mill flute region; and
a processing unit in communication with the PVDF sensor rosette comprising:
a charge amplifier, wherein the charge amplifier is configured to amplify the electric charge into one or more voltage signals;
a filter, wherein the filter is configured to filter the one or more voltage signals to remove aliasing from the one or more voltage signals;
a microcontroller unit (MCU), wherein the MCU is configured to:
acquire one or more digital voltage samples from the one or more voltage signals at a predetermined sampling period; and
generate cutting force data based on the digital voltage samples, wherein generating cutting force data comprises using one or more physics-based models, and wherein the cutting force data are used for relating the cutting force characteristics to the cutting forces acting on the end mill flute region; and
a digital storage medium, wherein the digital storage medium is configured to store one or more of the one or more digital voltage samples and the cutting force data for further processing.

16. The system of claim 14, wherein the sensor rosette is temperature compensated.

17. The system of claim 14, wherein the sensor rosette is configured to identify one or more of bending strain, shear strain, and axial strain.

18. The system of claim 14, wherein the sensor rosette is a bending strain rosette.

19. The system of claim 18, wherein the bending strain rosette comprises four sensors.

20. The system of claim 14, wherein the sensor rosette is configured to detect milling torque.
